(19) United States
(12) Patent Application Publication
(10) Pub. No.: US 2025/0003159 A1
(43) Pub. Date: Jan. 2, 2025

(54) ASPHALT FINISHER, AND POWER SUPPLY SYSTEM FOR ASPHALT FINISHER

(71) Applicant: SUMITOMO CONSTRUCTION MACHINERY CO., LTD., Tokyo (JP)

(72) Inventor: Hisaho MINO, Chiba (JP)

(21) Appl. No.: 18/883,181

(22) Filed: Sep. 12, 2024

Related U.S. Application Data
(63) Continuation of application No. PCT/JP2023/013340, filed on Mar. 30, 2023.

(30) Foreign Application Priority Data
Mar. 31, 2022 (JP) 2022-061327

(51) Int. Cl. E01C 19/48; B60L 50/60; B60L 53/16; B60L 55/00; E01C 19/00

(52) U.S. Cl. CPC E01C 19/4853; B60L 50/60; B60L 53/16; B60L 55/00; E01C 19/004; B60L 2200/40

(57) ABSTRACT

An asphalt finisher includes a tractor; a hopper provided on a front side of the tractor; a conveyer configured to convey a pavement material in the hopper to a rear side of the tractor; a screw configured to lay and spread the pavement material conveyed and placed on a road surface; a screed device configured to lay and level the pavement material behind the screw; an actuator configured to use electric power to supply power to at least one of the tractor, the conveyer, the screw, or the screed device; a power storage configured to supply the electric power to the actuator; and a connection part connectable to an external device and configured to receive supply of electric power from the external device or deliver electric power to the external device. The connection part is configured to supply the electric power from the external device to the power storage.

### CROSS-REFERENCE TO RELATED APPLICATIONS

This application is a continuation of International Application No. PCT/JP2023/013340,filed on Mar. 30, 2023 and designating the U.S., which claims priority to Japanese Patent Application No. 2022-061327, filed on Mar. 31, 2022. The contents of these applications are incorporated herein by reference in their entirety.

### BACKGROUND

### Technical Field

The present disclosure relates to an asphalt finisher, and a power supply system for an asphalt finisher.

### Description of Related Art

An asphalt finisher including a tractor, a hopper installed on the front side of the tractor and receiving a pavement material, a conveyor conveying the pavement material in the hopper to the rear side of the tractor, a screw laying and spreading the pavement material conveyed by the conveyor behind the tractor, and a screed laying and leveling the pavement material spread by the screw behind the screw is known.

In recent years, in consideration of the environment, there has been a tendency to propose techniques related to an electric vehicle including a motor driven by supplied electric power without including an internal combustion engine such as a diesel engine.

### SUMMARY

An asphalt finisher according to one embodiment of the present disclosure includes a tractor; a hopper provided on a front side of the tractor; a conveyer configured to convey a pavement material in the hopper to a rear side of the tractor; a screw configured to lay and spread, in a vehicle width direction, the pavement material conveyed by the conveyer and placed on a road surface; a screed device configured to lay and level the pavement material laid and spread by the screw behind the screw; an actuator configured to use electric power to supply power to at least one of the tractor, the conveyer, the screw, or the screed device; a power storage configured to supply the electric power to the actuator; and a connection part connectable to an external device and configured to receive supply of electric power from the external device or deliver electric power to the external device, wherein the connection part is configured to supply the electric power from the external device to the power storage.

A power supply system for an asphalt finisher according to one embodiment of the present disclosure includes an external device; and the asphalt finisher including a tractor, a hopper provided on a front side of the tractor, a conveyer configured to convey a pavement material in the hopper to a rear side of the tractor, a screw configured to lay and spread, in a vehicle width direction, the pavement material conveyed by the conveyer and placed on a road surface, a screed device configured to lay and level the pavement material laid and spread by the screw behind the screw, an actuator configured to use electric power to supply power to at least one of the tractor, the conveyer, the screw, or the screed device, a power storage configured to supply the electric power to the actuator, and a connection part connectable to the external device and configured to receive supply of electric power from the external device or deliver electric power to the external device, wherein the connection part is configured to supply the electric power from the external device to the power storage.

### BRIEF DESCRIPTION OF THE DRAWINGS

FIG. 1 is a top view illustrating a plurality of asphalt finishers according to an embodiment;

FIG. 2 is a side view of an asphalt finisher according to the embodiment;

FIG. 3 is a configuration diagram illustrating a hydraulic system and a power supply system installed in an asphalt finisher according to the embodiment; and

FIG. 4 is a diagram illustrating an example of wiring when the plurality of asphalt finishers according to the present embodiment are connected such that electric power can be supplied.

### DETAILED DESCRIPTION

In the related art, asphalt finishers typically include an internal combustion engine such as a diesel engine, and electrification was not considered.

In view of the above, an asphalt finisher including an actuator instead of an internal combustion engine such as a diesel engine is proposed.

According to one aspect of the present disclosure, an asphalt finisher can receive the supply of electric power or deliver electric power from or to an external device, and thus, at a work site where a device driven by electric power is used, work efficiency cab be improved.

Embodiments of the present disclosure will be described below with reference to the drawings. In the drawings, the same or corresponding configurations are denoted by the same reference numerals and a description thereof may be omitted.

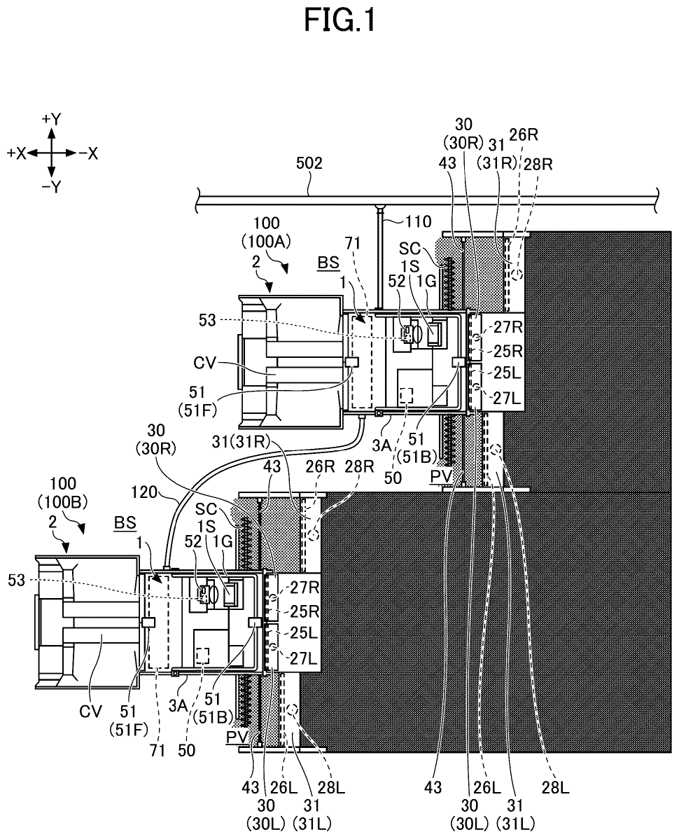

FIG. 1 is a top view illustrating a plurality of asphalt finishers 100A and 100B according to an embodiment. Specifically, FIG. 1 is a diagram illustrating a process in which a plurality of asphalt finishers 100 are laying and leveling a pavement material on a road surface, in other words, performing construction.

The asphalt finisher 100A and the asphalt finisher 100B illustrated in FIG. 1 are asphalt finishers having the same configuration, and in a case where either the asphalt finisher 100A or the asphalt finisher 100B is indicated, it is referred to as an asphalt finisher 100.

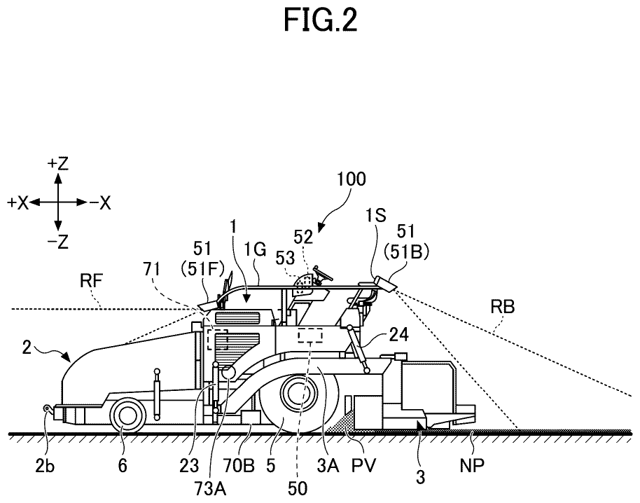

FIG. 2 is a side view of an asphalt finisher 100.

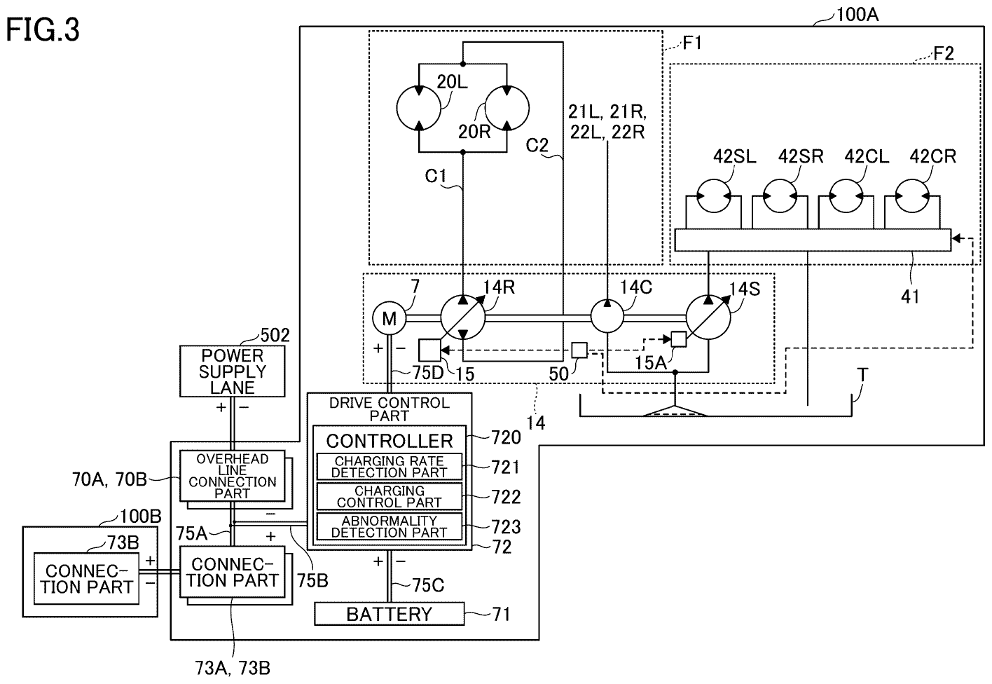

The asphalt finisher 100 according to the embodiment is an asphalt finisher that meets electric vehicle (EV) specifications, and includes a pump motor 7 (see FIG. 3), which serves as a motor, and a battery 71, which serves as a power storage. The asphalt finisher 100 according to the present embodiment includes the battery 71 within a tractor 1. Electric power supplied from the battery 71 is supplied to the pump motor 7. By using the electric power, the pump motor 7 supplies power to the tractor 1 and the screed 3.

The asphalt finisher 100 includes a connection part configured to receive the supply of electric power from an external device or configured to deliver electric power to an external device.

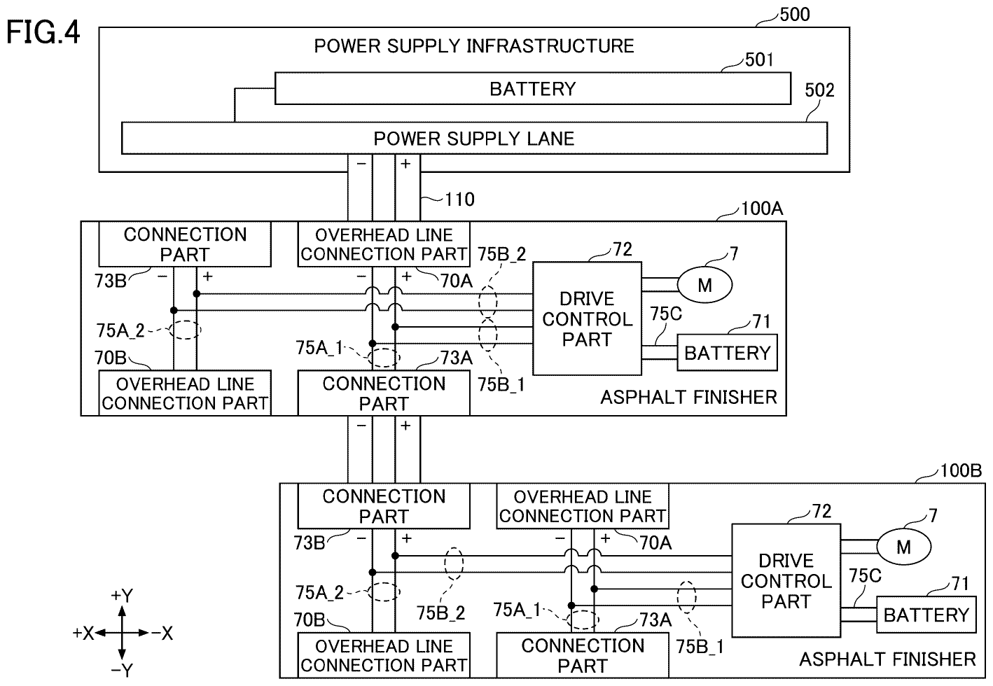

As illustrated in FIG. 2, an overhead line connection part 70B and a connection part 73A, which are examples of connection parts, are provided on the left side surface of the asphalt finisher 100. Similarly, an overhead line connection part 70A (see FIG. 4) and a connection part 73B (see FIG. 4), which are examples of connection parts, are provided on the right side surface of the asphalt finisher 100. In the present embodiment, although the examples of the connection parts provided on the asphalt finisher 100 are illustrated, installations of the connection parts are not limited to the illustrated example. That is, the asphalt finisher 100 may include one or more connection parts for receiving the supply of electric power from an external device or delivering electric power to an external device. For example, the asphalt finisher 100 may include only an overhead line connection part for receiving the supply of electric power from a power supply lane, may include only a connection part for receiving the supply of electric power from a connection part of another asphalt finisher 100, or may include only a connection part for delivering electric power to an external device.

The overhead line connection part 70A and the overhead line connection part 70B (which are an example of a first connection part) are provided so as to receive the supply of electric power from a power supply lane 502 provided along a route to be traveled by a vehicle. For example, the overhead line connection part 70A and the overhead line connection part 70B (which are the example of the first connection part) can be connected to a current collecting member 110 (a first member). In the present embodiment, by providing the overhead line connection part 70A and the overhead line connection part 70B, the power supply lane can be connected to the asphalt finisher 100 even when the power supply lane is located on either the right side or the left side of the asphalt finisher 100. Note that, if the power supply lane is predetermined to be located on either the right side or the left side of the asphalt finisher 100, either the overhead line connection part 70A or the overhead line connection part 70B may be provided. In the present embodiment, an example in which electric power is supplied from the power supply lane 502 will be described; however, electric power is not necessarily supplied from the power supply lane 502 and may be supplied from an external device such as a dump truck.

When the current collecting member 110 is connected to the overhead line connection part 70A or the overhead line connection part 70B, the current collecting member 110 extends from the side surface of the asphalt finisher 100 in the width direction of the asphalt finisher 100 (in the Y-axis direction), and one end of the current collecting member 110 can be in contact with the power supply lane 502 (an example of a power supply member). The current collecting member 110 is a member that can supply electric power from the power supply lane 502 (the example of the power supply member) with which the current collecting member 110 is in contact, to the overhead line connection part 70A or the overhead line connection part 70B to which the current collecting member 110 is connected. For example, the current collecting member 110 may be a member having rigidity to the extent that the asphalt finisher 100 and the power supply lane 502 can be connected to each other and capable of transmitting electric power.

In the example illustrated in FIG. 1, the current collecting member 110 is connected to the overhead line connection part 70A provided on the right side surface of the asphalt finisher 100A. The current collecting member 110 supplies electric power from the power supply lane 502, which is provided along a road surface under construction, to the overhead line connection part 70A.

The power supply lane 502 is a lane connected to an external power source such as a battery (see FIG. 4), provided along a road surface on which a vehicle travels, and configured to supply electric power to an electric vehicle including the asphalt finisher 100. For example, the power supply lane 502 is a rigid overhead line in which a positive electrode and a negative electrode are arranged in a V-shape.

The positions of the overhead line connection parts 70A and 70B in the height direction (in the Z-axis direction) are determined according to the position of the power supply lane 502 where a mechanism that can supply electric power is provided (for example, the position where the positive electrode and the negative electrode are arranged in a V-shape). The height of the mechanism of the power supply lane 502 that can supply electric power is, for example, 50 cm to 60 cm. Therefore, the height (in the Z-axis direction) of each of the overhead line connection parts 70A and 70B may also be 50 cm to 60 cm. Accordingly, the asphalt finisher 100A and the power supply lane 502 can be connected to each other such that electric power can be supplied.

The asphalt finisher 100 constructs a road surface while traveling in a state of being connected to the power supply lane 502 via the current collecting member 110. Accordingly, the asphalt finisher 100 can charge the battery 71 while constructing the road surface.

Further, a power supply cable 120 connects a connection part 73A (an example of a second connection part) provided on the left side surface of the asphalt finisher 100A and a connection part 73B (an example of a first connection part) provided on the right side surface of the asphalt finisher 100B. Accordingly, the asphalt finisher 100A can supply electric power supplied from the power supply lane 502 to the asphalt finisher 100B.

Next, a specific configuration of the asphalt finisher 100 will be described. The asphalt finisher 100 is mainly configured with the tractor 1, a hopper 2, and the screed 3 (an example of a screed device). Hereinafter, a direction (+X direction) of the hopper 2 as viewed from the tractor 1 is referred to as a forward direction, and a direction (−X direction) of the screed 3 as viewed from the tractor 1 is referred to as a backward direction. A road machine may also be a base paver, a tack paver, a multi-asphalt paver, or the like.

The tractor 1 is a mechanism for moving the asphalt finisher 100. In the present embodiment, the tractor 1 rotates rear wheels 5 by using a rear wheel travel hydraulic motor and rotates front wheels 6 by using a front wheel travel hydraulic motor to move the asphalt finisher 100. The rear wheel travel hydraulic motor and the front wheel travel hydraulic motor are supplied with hydraulic oil from a hydraulic pump to rotate. The rear wheels 5 and the front wheels 6 may be replaced with crawlers. Travel motors may also be electric motors.

The hopper 2 is a mechanism for receiving a pavement material. In the present embodiment, the hopper 2 is installed on the front side of the tractor 1 and is configured to be openable and closable in the vehicle width direction (the Y-axis direction) by a hopper cylinder. Typically, the asphalt finisher 100 fully opens the hopper 2 to receive a pavement material (such as an asphalt mixture) from the bed of a dump truck. The dump truck is an example of a transport vehicle that transports a pavement material. FIG. 1 illustrates the hopper 2 in a fully opened state. When a pavement material in the hopper 2 is reduced, the hopper 2 is closed and the pavement material near the inner wall of the hopper 2 is gathered to the center of the hopper 2 so that a conveyor CV in the center of the hopper 2 can convey the pavement material to the rear side of the tractor 1. The pavement material conveyed to the rear side of the tractor 1 is laid and spread in the vehicle width direction behind the tractor 1 and in front of the screed 3 by a screw SC. In the present embodiment, the screw SC has extension screws connected to left and right sides thereof. In FIG. 1, a pavement material PV laid and spread by the screw SC is indicated by a dot pattern.

The screed 3 is a mechanism for laying and leveling the pavement material PV. In the present embodiment, as illustrated in FIG. 1, the screed 3 includes a front screed 30 and a rear screed 31. The front screed 30 includes a left front screed 30L and a right front screed 30R. The rear screed 31 includes a left rear screed 31L and a right rear screed 31R. The screed 3 is a floating screed towed by the tractor 1, and is coupled to the tractor 1 through a leveling arm 3A.

A screed lift cylinder 24 extends and retracts to move the screed 3 up and down together with the leveling arm 3A.

A leveling cylinder 23 is a hydraulic cylinder that moves up and down the front end portion of the leveling arm 3A so as to adjust the thickness of the pavement material to be laid and leveled. In the present embodiment, the leveling cylinder 23 has a cylinder part coupled to the tractor 1 and a rod part coupled to a coupling portion between the leveling arm 3A and the tractor 1. In the case of increasing the thickness of the pavement material to be laid and leveled, a controller 50 (see FIG. 3) causes hydraulic oil discharged by a hydraulic pump to flow into a rod-side oil chamber of the leveling cylinder 23 so that the leveling cylinder 23 retracts and the leveling arm 3A is raised. In the case of decreasing the thickness of the pavement material to be laid and leveled, the controller 50 causes hydraulic oil in the rod-side oil chamber of the leveling cylinder 23 to flow out so that the leveling cylinder 23 extends and the leveling arm 3A is lowered.

The screed lift cylinder 24 is a hydraulic cylinder for lifting the screed 3. In the present embodiment, the screed lift cylinder 24 has a cylinder part coupled to the tractor 1 and a rod part coupled to the rear end portion of the leveling arm 3A. In the case of lifting the screed 3, the controller 50 causes hydraulic oil discharged by the hydraulic pump to flow into a rod-side oil chamber of the screed lift cylinder 24. As a result, the screed lift cylinder 24 retracts, the rear end portion of the leveling arm 3A is lifted, and the screed 3 is lifted. In the case of lowering the lifted screed 3, the controller 50 allows the hydraulic oil in the rod-side oil chamber of the screed lift cylinder 24 to flow out. As a result, the screed lift cylinder 24 extends because of the weight of the screed 3, so that the rear end portion of the leveling arm 3A is lowered and the screed 3 is lowered.

A mold board 43 is attached to the front portion of the screed 3. The mold board 43 is configured to adjust the amount of the pavement material PV accumulated in front of the screed 3. The pavement material PV reaches under the screed 3 through a gap between the lower end of the mold board 43 and a roadbed BS.

The screed 3 is provided with a left front tamper 25L, a right front tamper 25R, a left rear tamper 26L, and a right rear tamper 26R (hereinafter also collectively referred to as tampers 25 and 26). The left front screed 30L finishes a road surface tamped and compacted by the left front tamper 25L. The right front screed 30R finishes a road surface tamped and compacted by the right front tamper 25R. The left rear screed 31L finishes a road surface tamped and compacted by the left rear tamper 26L. The right rear screed 31R finishes a road surface tamped and compacted by the right rear tamper 26R.

The tampers 25 and 26 move a tamper edge (not illustrated) up and down through a tamper shaft (not illustrated) that is partially eccentric by rotation of a motor (not illustrated) provided in the screed 3. Accordingly, the tampers 25 and 26 tamp down a road surface.

The screed 3 is provided with a left front vibrator 27L, a right front vibrator 27R, a left rear vibrator 28L, and a right rear vibrator 28R (hereinafter also collectively referred to as vibrators 27 and 28). Then, the left front screed 30L is vibrated by the left front vibrator 27L, and the right front screed 30R is vibrated by the right front vibrator 27R. The left rear screed 31L is vibrated by the left rear vibrator 28L, and the right rear screed 31R is vibrated by the right rear vibrator 28R.

The vibrators 27 and 28 are vibration devices for compacting a pavement surface. In the present embodiment, the vibrators 27 and 28 are eccentric vibrators driven by a hydraulic motor. However, the vibrators may be driven by an electric motor, or may be linear vibrators. According to the present embodiment, the vibration frequency is changed according to the type of the pavement material and the like.

The controller 50 is a control device that controls the asphalt finisher 100. In the present embodiment, the controller 50 includes a microcomputer including a CPU, a memory, and a non-volatile storage device, and is installed in the tractor 1. Functions of the controller 50 are implemented by the CPU executing a program stored in the non-volatile storage device. However, the functions of the controller 50 may be implemented by, for example, hardware or firmware.

A communication device 53 is configured to control communication between the asphalt finisher 100 and a device located outside the asphalt finisher 100. The communication device 53 according to the present embodiment is installed in front of a driver's seat 1S and controls communication via a mobile phone communication network, a short-range wireless communication network, a satellite communication network, or the like. For example, the communication device 53 may control communication between asphalt finishers 100.

A space recognition device 51 is attached to the tractor 1. The space recognition device 51 is configured to acquire information related to a space around the asphalt finisher 100 and output the acquired information to the controller 50. The space recognition device 51 according to the present embodiment includes a front monitoring device 51F and a rear monitoring device 51B.

The front monitoring device 51F is configured to monitor an area in front of the asphalt finisher 100. In the present embodiment, the front monitoring device 51F is a LIDAR whose monitoring range RF is a space in front of the tractor 1, and is attached to the center of the front end portion of the upper surface of the tractor 1. The front monitoring device 51F may be attached to another part of the asphalt finisher 100.

The rear monitoring device 51B is configured to monitor an area behind the asphalt finisher 100. In the present embodiment, the rear monitoring device 51B is a LIDAR whose monitoring range RB is a space behind the screed 3, and is attached to a guide rail 1G serving as a handrail for an operator of the asphalt finisher 100. The rear monitoring device 51B may be attached to a lower part of the driver's seat 1S, or may be attached to another part of the asphalt finisher 100.

The space recognition device 51 may include a side monitoring device configured to monitor an area to the side of the asphalt finisher 100. In this case, the side monitoring device may be attached to, for example, the left end of the upper surface of the tractor 1 on the front side of the rear wheels 5 as a LIDAR whose monitoring range is a space to the left of the tractor 1. The side monitoring device may also be attached to, for example, the right end of the upper surface of the tractor 1 on the front side of the rear wheels 5 as a LIDAR whose monitoring range is a space to the right of the tractor 1.

A LIDAR measures the distances between the LIDAR and one million points or more within a monitoring range, for example. However, at least one of the front monitoring device 51F or the rear monitoring device 51B may be a monocular camera, a stereo camera, a millimeter wave radar, a laser radar, a laser scanner, a distance image camera, a laser range finder, or the like. The same applies to the side monitoring device. In the embodiment, an example in which the LIDAR is used as an example of the space recognition device 51 has been described. However, the present embodiment does not limit the space recognition device 51 to the LIDAR. That is, a space recognition device that can recognize a space with reference to the asphalt finisher 100 may be used.

The monitoring range RF of the front monitoring device 51F desirably includes the roadbed BS. The same applies to the monitoring range of the side monitoring device. In the present embodiment, the monitoring range RF is wider than the roadbed BS where the pavement material is to be laid and spread by the asphalt finisher 100.

The monitoring range RB of the rear monitoring device 51B desirably includes a newly constructed pavement NP. In the present embodiment, the monitoring range RB is wider than the newly constructed pavement NP where the pavement material is laid and spread by the asphalt finisher 100.

As illustrated in FIG. 1, in a case where the asphalt finisher 100A and the asphalt finisher 100B are connected by the power supply cable 120, a monitoring range RF of the asphalt finisher 100A includes a part of the asphalt finisher 100B, and a monitoring range RB of the asphalt finisher 100B includes a part of the asphalt finisher 100A.

Measurement information detected by the space recognition device 51 according to the present embodiment is transmitted to the controller 50. The controller 50 may automatically steer the asphalt finisher 100 or may notify a driver of a warning or the like based on the received measurement information.

Further, the controller 50 of the asphalt finisher 100 can recognize the relative positional relationship between asphalt finishers 100 from the measurement information detected by the space recognition device 51. The controller 50 may receive the travel speed of another asphalt finisher 100 via the communication device 53.

Therefore, when the connection part 73B of the asphalt finisher 100B is connected to the connection part 73A of the asphalt finisher 100A via the power supply cable 120, a controller 50 of the asphalt finisher 100B may perform speed control such that the asphalt finisher 100B travels in parallel with the asphalt finisher 100A based on the relative positional relationship with the asphalt finisher 100A and the travel speed of the asphalt finisher 100A. For example, the controller 50 of the asphalt finisher 100B determines whether the distance between the asphalt finisher 100B and the asphalt finisher 100A is less than or equal to a predetermined threshold based on measurement information of a space recognition device 51. Then, if the distance between the asphalt finisher 100B and the asphalt finisher 100A is equal to or less than the predetermined threshold, the controller 50 of the asphalt finisher 100B performs control such that the asphalt finisher 100B travels at the same speed as the asphalt finisher 100A in accordance with the received travel speed. Conversely, if the distance between the asphalt finisher 100B and the asphalt finisher 100A exceeds the predetermined threshold, the controller 50 of the asphalt finisher 100B performs control to increase or decrease the speed such that the distance between the asphalt finisher 100B and the asphalt finisher 100A becomes equal to or less than the predetermined threshold. This can suppress a deviation in the distance between the asphalt finisher 100A and the asphalt In finisher 100B due to an inclination or the like. other words, it is possible to perform control such that the connection between the asphalt finisher 100A and the asphalt finisher 100B via the power supply cable 120 is maintained. In the present embodiment, an example in which the controller 50 of the asphalt finisher 100B performs speed control has been described; however, a controller 50 of the asphalt finisher 100A may perform speed control such that the asphalt finisher 100A travels in parallel with the asphalt finisher 100B. Further, each of the controller 50 of the asphalt finisher 100B and the controller 50 of the asphalt finisher 100A may perform speed control. In the present embodiment, a burden on an operator can be reduced by the speed control.

Further, the present embodiment is not limited to a configuration in which one or both of the controller 50 of the asphalt finisher 100B and the controller 50 of the asphalt finisher 100A perform speed control. In the present embodiment, one or both of the controller 50 of the asphalt finisher 100B and the controller 50 of the asphalt finisher 100A may perform steering angle control. In this case, at least one of the controller 50 of the asphalt finisher 100B or the controller 50 of the asphalt finisher 100A may perform steering angle control in accordance with predetermined route information. When the asphalt finisher 100A and the asphalt finisher 100B move in accordance with the route information, the connection between the asphalt finisher 100A and the asphalt finisher 100B via the power supply cable 120 can be maintained. Further, based on the steering angle of a preceding asphalt finisher, the controller 50 of a following asphalt finisher may perform steering angle control so as to follow the preceding asphalt finisher while laying and leveling the pavement material on a road surface different from a road surface on which the preceding asphalt finisher travels. Accordingly, the connection via the power supply cable 120 can be maintained. In the present embodiment, a burden on an operator can be reduced by the steering angle control. Information on the steering angle of the preceding asphalt finisher 100 may be received from the preceding asphalt finisher 100 via a communication device 53.

Further, in the present embodiment, control performed by each of the controllers 50 is not limited to the above-described control, and any control may be performed as long as the inter-vehicle distance does not increase. For example, if an operator of a preceding asphalt finisher, among the asphalt finisher 100A and the asphalt finisher 100B, performs steering so as to increase the speed or move away from a following asphalt finisher, the controller 50 of the preceding asphalt finisher may perform control to limit the increase in the speed or limit the steering. Similarly, if an operator of the following asphalt finisher performs steering so as to decrease the speed or move away from the preceding asphalt finisher, the controller 50 of the following asphalt finisher may perform control to limit the decrease in the speed or limit the steering. As described above, each of the controllers 50 may perform any control so as to suppress the possibility that the power supply cable 120 is disconnected or the power supply cable 120 is cut as a result of an increase in the inter-vehicle distance between the asphalt finishers 100.

As described above, each of the asphalt finishers 100 according to the present embodiment may be operated by an operator or may be automatically controlled as long as the connection of the power supply cable 120 can be maintained.

Next, a hydraulic system and a power supply system installed in the asphalt finisher 100A will be described with reference to FIG. 3. FIG. 3 is a diagram illustrating an example configuration of the hydraulic system and the power supply system installed in the asphalt finisher 100A. Note that a configuration of the asphalt finisher 100B is the same as that of the asphalt finisher 100A, and thus a description thereof will be omitted.

The hydraulic system mainly includes a hydraulic source 14, a rear wheel drive part F1, and a conveyor and screw drive part F2.

The hydraulic source 14 is a functional component that supplies hydraulic oil for operating various hydraulic drive parts including the rear wheel drive part F1 and the conveyor and screw drive part F2. In the present embodiment, the hydraulic source 14 mainly includes a pump motor 7, a rear wheel travel pump 14R, a charge pump 14C, and a conveyor and screw pump 14S.

The pump motor 7 (an example of an electric actuator, which is a type of motor) is a drive source that drives the rear wheel travel pump 14R, the charge pump 14C, and the conveyor and screw pump 14S with electric power supplied from a battery 71. That is, the pump motor 7 (the example of the electric actuator) drives the tractor 1, a conveyor, a screw, and the screed 3 by supplying power to the rear wheel travel pump 14R, the charge pump 14C, and the conveyor and screw pump 14S. Note that, in the present embodiment, an example in which the pump motor 7 (the example of the electric actuator) drives all of the tractor 1, the conveyor, the screw, and the screed 3 will be described; however, the present invention is not limited to such a control method, and one electric actuator may drive any one or more of the tractor 1, the conveyor, the screw, and the screed 3.

The rear wheel travel pump 14R is a variable displacement hydraulic pump that supplies hydraulic oil for driving to the rear wheel drive part F1. In the present embodiment, the rear wheel travel pump 14R is a swash plate variable displacement bi-directional hydraulic pump used in a closed circuit (HST), and the discharge quantity of the rear wheel travel pump 14R is controlled by a pump regulator 15. Technically, the discharge quantity is a discharge quantity per pump revolution, and is also referred to as a geometric displacement.

The pump regulator 15 is a device that controls the discharge quantity of the rear wheel travel pump 14R. In the present embodiment, the pump regulator 15 controls the discharge quantity of the rear wheel travel pump 14R in accordance with a pump command current from the controller 50 of the asphalt finisher 100. For example, the pump regulator 15 increases the discharge quantity of the rear wheel travel pump 14R as the current value of the pump command current increases.

The charge pump 14C is a fixed displacement hydraulic pump that supplies hydraulic oil for control to the rear wheel drive part F1.

The conveyor and screw pump 14S is a variable displacement hydraulic pump that supplies hydraulic oil to the conveyor and screw drive part F2. In the present embodiment, the conveyor and screw pump 14S is a swash plate variable displacement hydraulic pump. In the present embodiment, the discharge quantity of the conveyor and screw pump 14S is controlled by a pump regulator 15A. The pump regulator 15A adjusts the discharge quantity of the conveyor and screw pump 14S in accordance with a pump command current from the controller 50. For example, the pump regulator 15A increases the discharge quantity of the conveyor and screw pump 14S as the current value of the pump command current increases.

The rear wheel drive part F1 is a functional component that drives the rear wheels of the tractor 1. In the present embodiment, the rear wheel drive part F1 includes a left rear wheel travel motor 20L and a right rear wheel travel motor 20R.

The left rear wheel travel motor 20L is a hydraulic motor that drives a left rear wheel 5 (see FIG. 1) of the tractor 1. Further, the right rear wheel travel motor 20R is a hydraulic motor that drives a right rear wheel 5 (see FIG. 1) of the tractor 1. In the present embodiment, the left rear wheel travel motor 20L and the right rear wheel travel motor 20R are variable displacement hydraulic motors, and form a closed circuit (HST) together with the rear wheel travel pump 14R. Alternatively, the left rear wheel travel motor 20L and the right rear wheel travel motor 20R may be fixed displacement hydraulic motors. The rear wheel travel pump 14R is connected to the left rear wheel travel motor 20L and the right rear wheel travel motor 20R via conduits C1 and C2 through which hydraulic oil flows.

A reduction ratio control device 21L is a device that controls the reduction ratio of a speed reducer coupled to the left rear wheel travel motor 20L. In the present embodiment, the reduction ratio control device 21L controls the reduction ratio of the speed reducer coupled to the left rear wheel travel motor 20L by using hydraulic oil discharged by the charge pump 14C in response to a control command from the controller 50. The same applies to a reduction ratio control device 21R that controls the reduction ratio of a speed reducer coupled to the right rear wheel travel motor 20R.

A brake control device 22L is a device that controls the braking force of a left rear wheel brake that brakes the left rear wheel 5 of the asphalt finisher 100. In the present embodiment, the brake control device 22L controls the braking force of the left rear wheel brake by using hydraulic oil discharged by the charge pump 14C in response to a control command from the controller 50. The same applies to a brake control device 22R that controls the braking force of a right rear wheel brake.

The conveyor and screw drive part F2 is a functional component that drives a conveyor and a screw SC. In the present embodiment, the conveyor and screw drive part F2 mainly includes a left screw motor 42SL, a right screw motor 42SR, a left conveyor motor 42CL, a right conveyor motor 42CR, and a conveyor and screw valve 41.

Each of the left screw motor 42SL, the right screw motor 42SR, the left conveyor motor 42CL, and the right conveyor motor 42CR is a fixed displacement hydraulic motor that forms an open circuit.

The conveyor and screw valve 41 includes a conveyor control valve and a screw control valve. The conveyor control valve switches in response to a control command from the controller 50. Hydraulic oil discharged by the conveyor and screw pump 14S flows into an intake port of at least one of the left conveyor motor 42CL or the right conveyor motor 42CR. Further, hydraulic oil flowing out of a discharge port of at least one of the left conveyor motor 42CL or the right conveyor motor 42CR is discharged into a hydraulic oil tank T. The screw control valve switches in response to a control command from the controller 50. Hydraulic oil discharged by the conveyor and screw pump 14S flows into an intake port of at least one of the left screw motor 42SL or the right screw motor 42SR. Hydraulic oil flowing out of a discharge port of at least one of the left screw motor 42SL or the right screw motor 42SR is discharged into the hydraulic oil tank T.

The power supply system mainly includes overhead line connection parts 70A and 70B, the battery 71, a drive control part 72, and connection parts 73A and 73B.

The battery 71, which serves as a power storage, is, for example, a lithium ion secondary battery, but may be any rechargeable secondary battery.

The overhead line connection part 70A or 70B (an example of a first connection part) can be connected to the power supply lane 502 (an example of a first external device) via the current collecting member 110, and the overhead line connection part 70A or 70B is connected to an electric power line 75A for receiving the supply of electric power from the power supply lane 502 when connected to the power supply lane 502.

The connection part 73A or 73B (an example of a second connection part) can be respectively connected to a connection part 73B or 73A (an example of a first connection part) of another asphalt finisher 100 (an example of a second external device) via the power supply cable 120, and can deliver electric power supplied via the electric power line 75A to the other asphalt finisher 100. Note that, in the present embodiment, an example in which electric power is delivered to the other asphalt finisher 100 will be described; however, electric power can be delivered to any external device connectable to the connection part 73A or 73B.

The connection part 73B or 73A (an example of a first connection part) may be connected to the connection part 73A or 73B (an example of a second connection part) of the other asphalt finisher 100 (an example of a first external device) via the power supply cable 120, and may receive the supply of electric power from the other asphalt finisher 100.

The overhead line connection parts 70A and 70B and the connection parts 73A and 73B are connected by the electric power line 75A for supplying electric power. One end of an electric power line 75B is connected to the electric power line 75A, and the other end of the electric power line 75B is connected to the drive control part 72.

The drive control part 72 and the battery 71 are connected by an electric power line 75C for supplying electric power to the battery 71 or receiving electric power supplied from the battery 71. The drive control part 72 and the pump motor 7 are connected by an electric power line 75D for supplying electric power from the battery 71 to the pump motor 7.

With the above-described configuration, the overhead line connection part 70A or 70B can charge the battery 71 with electric power supplied from the power supply lane 502 via the electric power line 75A, the electric power line 75B, and the electric power line 75C. Further, the overhead line connection part 70A or 70B can supply electric power supplied from the power supply lane 502 to the other asphalt finisher 100 from the connection part 73A or 73B (an example of a second connection part) via the electric power line 75A.

Further, the connection part 73A or 73B can charge the battery 71 with electric power, supplied from the other asphalt finisher 100, via the electric power line 75A, the electric power line 75B, and the electric power line 75C.

In the present embodiment, a method of connection via the current collecting member 110 has been described as a method of connecting the overhead line connection part 70A or 70B to the power supply lane 502. However, the connection method described in the present embodiment is an example and is not limited to the method of connection via the current collecting member 110. For example, the overhead line connection part 70A or 70B and the power supply lane 502 may be connected in a contactless manner, and the overhead line connection part 70A or 70B may receive the supply of electric power from the power supply lane 502.

Further, the present embodiment is not limited to a method of receiving the supply of electric power from an overhead line such as the power supply lane 502 provided to the side of the asphalt finisher 100. For example, a power supply facility may be buried under the road. In this case, a connection part provided on the bottom surface of the asphalt finisher 100 is supplied with electric power from the buried power supply facility.

In the present embodiment, a method of connection via the power supply cable 120 has been described as a method of connecting the connection part 73A (an example of a second connection part) of the asphalt finisher 100A and the connection part 73B (an example of a first connection part) of the asphalt finisher 100B. However, the connection method described in the present embodiment is an example and is not limited to the method of connection via the power supply cable 120 or the like. For example, the connection part 73A of the asphalt finisher 100A and the connection part 73B of the asphalt finisher 100B may be connected in a contactless manner, and the connection part 73B of the asphalt finisher 100B may receive the supply of electric power from the connection part 73A of the asphalt finisher 100A.

The drive control part 72 includes a controller 720, and controls the driving of the asphalt finisher 100.

Further, the drive control part 72 may include an inverter for controlling the driving (for example, the rotational speed) of the pump motor 7 when electric power from the battery 71 is supplied to the pump motor 7. In addition, the drive control part 72 may further include a converter for controlling the charge and discharge of the battery 71 (for example, for stepping down electric power supplied from a dump truck). Further, the drive control part 72 may be provided with a filter and a capacitor for maintaining a voltage on the upstream side of the inverter.

The controller 720 includes a charging rate detection part 721, a charging control part 722, and an abnormality detection part 723, and performs control to charge the battery 71 with electric power supplied from the power supply lane 502 or the other asphalt finisher 100.

The charging rate detection part 721 detects the charging rate (state of charge: SOC) of the battery 71.

The charging control part 722 performs control such that the battery 71 is charged with electric power supplied from the power supply lane 502 or the other asphalt finisher 100.

The abnormality detection part 723 detects whether there is an abnormality in charging the battery 71. For example, the abnormality detection part 723 may detect whether the battery is overcharged based on the SOC detected by the charging rate detection part 721 and the control state of the charging control part 722. If the abnormality detection part 723 detects that the battery is overcharged, the abnormality detection part 723 may instruct the charging control part 722 to end charging.

Further, if the abnormality detection part 723 detects that an abnormality has occurred, the abnormality detection part 723 may notify the operator of the asphalt finisher 100 of the occurrence of the abnormality by sounds or the like.

FIG. 4 is a diagram illustrating an example of wiring when the asphalt finisher 100A and the asphalt finisher 100B according to the present embodiment are connected such that electric power can be supplied.

FIG. 4 illustrates an example in which the asphalt finisher 100A and the asphalt finisher 100B receive the supply of electric power from a power supply infrastructure 500.

The power supply infrastructure 500 includes a battery 501 and the power supply lane 502. The power supply infrastructure 500 supplies electric power from the battery 501 to an electric vehicle (including the asphalt finisher 100) connected to the power supply lane 502.

As illustrated in FIG. 4, the asphalt finisher 100A and the asphalt finisher 100B include the connection parts 73B and the overhead line connection parts 70A on the right side surfaces (on the +Y side) thereof, and include the connection parts 73A and the overhead line connection parts 70B on the left side surfaces (on the −Y side) thereof.

In each of the asphalt finisher 100A and the asphalt finisher 100B, the connection part 73A on the left side surface (on the −Y side) and the overhead line connection part 70A on the right side surface (on the +Y side) are connected to each other by an electric power line 75A_1. Similarly, in each of the asphalt finisher 100A and the asphalt finisher 100B, the connection part 73B on the right side surface (+Y side) and the overhead line connection part 70B on the left side surface (−Y side) are connected to each other by an electric power line 75A_2. Therefore, electric power supplied from the power supply infrastructure 500 to one of the asphalt finishers 100 through the overhead line connection part 70A or 70B can be supplied to the other asphalt finisher 100 through the connection part 73A or 73B.

One end of an electric power line 75B_1 is connected to the electric power line 75A_1, and the other end of the electric power line 75B_1 is connected to the drive control part 72. Similarly, one end of an electric power line 75B_2 is connected to the electric power line 75A_2, and the other end of the electric power line 75B_2 is connected to the drive control part 72. Therefore, the electric power lines 75B_1 and 75B_2 can supply electric power flowing through the electric power line 75A_1 and the electric power line 75A_2 to the battery 71 via the drive control part 72.

In the example illustrated in FIG. 4, the overhead line connection part 70A of the asphalt finisher 100A is supplied with electric power from the power supply lane 502 of the power supply infrastructure 500 via the current collecting member 110.

Then, in the asphalt finisher 100A, the battery 71 is charged with the electric power supplied from the overhead line connection part 70A via the electric power line 75A_1, the electric power line 75B_1, the drive control part 72, and the electric power line 75C. In parallel with the charging, the electric power supplied from the overhead line connection part 70A flows through the electric power line 75A_1 and is supplied to the connection part 73B of the asphalt finisher 100B from the connection part 73A of the asphalt finisher 100A.

Then, in the asphalt finisher 100B, the battery 71 is charged with the electric power supplied from the connection part 73B through the electric power line 75A_2, the electric power line 75B_2, the drive control part 72, and the electric power line 75C.

In the example illustrated in FIG. 4, the power supply infrastructure 500 is provided on the right side (+Y side) of the asphalt finisher 100A. However, the present embodiment is not limited to the example in which the power supply infrastructure 500 is provided on the right side (+Y side) of the asphalt finisher 100A. That is, each asphalt finisher 100 includes the overhead line connection parts 70A and 70B on both side surfaces, and thus can receive the supply of electric power regardless of whether the power supply infrastructure 500 is located on the right side or the left side of the asphalt finisher 100.

Further, because the connection parts 73A and 73B are provided on both side surfaces of the asphalt finisher 100, even when the other asphalt finisher 100 is present on either the right side or the left side, the asphalt finisher 100 can supply electric power to the other asphalt finisher 100 and can also receive electric power from the other asphalt finisher 100.

Note that the electric power lines of the asphalt finishers 100A and 100B illustrated in FIG. 4 are illustrated as examples, and any wiring may be used as long as each of the asphalt finishers 100A and 100B can supply electric power and can receive electric power from either of the side surfaces.

In the present embodiment, an example in which an external device that supplies electric power is the power supply lane 502 of the power supply infrastructure or the other asphalt finisher 100 has been described. However, in the present embodiment, the external device that supplies electric power is not limited to the power supply lane 502 of the power supply infrastructure or the other asphalt finisher 100, and may be any device. For example, the external device that supplies electric power may be a dump truck that supplies a pavement material, any other work equipment, or the like.

In the present embodiment, the asphalt finisher 100 is supplied with electric power from the power supply lane 502 of the power supply infrastructure 500, and thus a decrease in the SOC of the battery 71 can be suppressed. Therefore, even after the supply of the electric power from the power supply lane 502 of the power supply infrastructure 500 is stopped, the asphalt finisher 100 can construct a road surface or the like by using electric power from the battery 71. Further, the asphalt finisher 100 according to the present embodiment can supply electric power held in the battery 71 to an external device from the connection part 73A or 73B, and thus the asphalt finisher 100 can supply electric power to the other asphalt finisher 100 when the other asphalt finisher 100 has become difficult to continue the operation due to a shortage of electric power. Therefore, the operation of the other asphalt finishers 100 is less likely to be stopped, and an improvement in safety can be achieved.

### First Modification

In the above-described embodiment, an example in which the asphalt finishers 100A and 100B includes the respective batteries 71 has been described. However, the above-described embodiment is not limited to the example in which the asphalt finishers 100A and 100B includes the respective batteries 71.

Asphalt finishers 100A and 100B according to a first modification do not include batteries 71. The asphalt finishers 100A and 100B are driven by electric power supplied from the power supply lane 502 of the power supply infrastructure 500.

The present modification is not limited to a case in which the asphalt finishers 100A and 100B do not include batteries 71, and either the asphalt finisher 100A or the asphalt finisher 100B may be configured not to include a battery 71. In this case, if the supply of electric power from the power supply lane 502 of the power supply infrastructure 500 is stopped, the battery 71 provided in either the asphalt finisher 100A or the asphalt finisher 100B supplies electric power to each of the asphalt finisher 100A and the asphalt finisher 100B. Thus, the asphalt finisher 100A and the asphalt finisher 100B can travel in parallel.

### Second Modification

In a second modification, various examples of supplying electric power from an asphalt finisher 100 to another asphalt finisher 100 or an external device will be described.

In the above-described embodiment, an example in which an asphalt finisher 100 is provided with connection parts 73A and 73B for connecting to another asphalt finisher 100 has been described. However, the number of connection parts 73A and 73B for connecting to another asphalt finishers 100 is not limited, and one or three or more connection parts may be provided. Similarly, the number of overhead line connection parts 70A and 70B for connecting to the power supply lane is not limited, and one or three or more overhead line connection parts may be provided.

An asphalt finisher 100 according to the present modification includes a plurality of connection parts. Therefore, the amount of electric power supplied to one or two or more other asphalt finishers 100 can be increased. Further, electric power can be supplied between another asphalt finishers 100 and an external device via the asphalt finisher 100 according to the present modification.

In a case where the asphalt finisher 100 according to the present modification does not include a battery 71, the asphalt finisher 100 according to the present modification may receive electric power from an external device (for example, the power supply lane 502 of the power supply infrastructure) and supply the electric power to another external device.

Further, in a case where the asphalt finisher 100 according to the present modification includes a battery 71, the asphalt finisher 100 according to the present modification may deliver electric power to another external device (for example, another asphalt finisher 100) without being connected to an external device (for example, the power supply lane 502 of the power supply infrastructure). With the above-described configuration, the asphalt finisher 100 according to the present modification can travel in parallel with another asphalt finisher 100 that does not include a battery 71 (or whose battery 71 has a low SOC), and can lay and level a pavement material even on a road surface on which the power supply lane 502 is not provided.

### Effects

In the above-described embodiment, an asphalt finisher 100 can receive electric power supplied from an external device (for example, the power supply lane 502 or another asphalt finisher 100). Therefore, the asphalt finisher 100 can charge the battery 71 or construct a road surface with electric power supplied from the external device.

Accordingly, when the supply of electric power is stopped, the possibility of stopping the operation of the asphalt finisher 100 can be reduced.

Further, the asphalt finisher 100 can deliver electric power to an external device (for example, the other asphalt finisher 100). Therefore, the external device such as the other asphalt finisher 100 can perform various processes (for example, charging of the battery 71 or construction of a road surface) with the electric power supplied from the asphalt finisher 100. Accordingly, when the supply of electric power is stopped, the possibility of stopping the operation of the external device can be reduced.

Further, because electric power is sequentially supplied from an external device (for example, the power supply lane 502 or the other asphalt finisher 100), the capacity of the battery 71 may be reduced, or the battery 71 is not necessarily provided. Accordingly, an increase in the weight of the asphalt finisher 100 can be suppressed, and cost reduction can also be achieved.

The asphalt finisher 100 can supply electric power supplied from one external device to another external device. That is, electric power supplied from one external device can be used by a plurality of devices including the asphalt finisher 100. Accordingly, work efficiency and convenience during work can be improved.

In the above-described embodiment, the asphalt finisher 100 can be supplied with electric power from an external device and supplied with electric power from the battery 71. That is, an electric power supply source can be duplexed. Therefore, even when the supply of electric power from either the external device or the battery is stopped during construction of a road surface, the asphalt finisher 100 can continue the construction of the road surface, and thus stability can be improved.

Further, in a situation where the amount of power consumption is small, for example, in a situation where the asphalt finisher 100 is only moved, the asphalt finisher 100 can charge the battery 71 while being moved by electric power supplied from an external device. Therefore, in a case where the asphalt finisher 100 is scheduled to construct a road surface or the like, the asphalt finisher 100 can move to the road surface while improving the SOC of the battery 71, and thus the stability of the future operation of the asphalt finisher 100 can be improved.

Further, the asphalt finisher 100 can supply electric power to the other asphalt finisher 100. Thus, a plurality of asphalt finishers 100 can perform construction work in parallel. Accordingly, work efficiency can be improved.

Further, when the asphalt finisher 100 travels while being connected to the other asphalt finisher 100 via the power supply cable 120, the asphalt finisher 100 performs speed control so as to maintain the connection to the other asphalt finisher 100 via the power supply cable 120 while supplying electric power between the asphalt finishers 100. Alternatively, when the asphalt finisher 100 travels while being connected to the other asphalt finisher 100 via the power supply cable 120, the asphalt finisher 100 performs steering angle control based on the steering angle of the other asphalt finisher 100 so as to maintain the connection to the other asphalt finisher 100 via the power supply cable 120 while supplying electric power between the asphalt finishers 100.

Accordingly, the inter-vehicle distance can be appropriately maintained, and thus the supply of electric power is less likely to be stopped and a steering load on an operator can be reduced.

The asphalt finisher 100 described above can be driven by electric power supplied from the power supply lane 502 or an external device such as the other asphalt finisher 100. Accordingly, the asphalt finisher 100 can perform work in consideration of the environment as compared to an asphalt finisher using an internal combustion engine.

In the above-described embodiment, electric power supplied from the battery 71 generates rotational power of the pump motor 7 (an example of the electric actuator), and the rotational power of the pump motor 7 drives the rear wheel travel pump 14R, the charge pump 14C, and the conveyor and screw pump 14S. However, the above- described embodiment is not limited to such a configuration. As a modification, at least one of the rear wheel travel pump 14R, the charge pump 14C, or the conveyor and screw pump 14S may be replaced with an electric actuator (for example, a pump motor). In this modification, electric power is supplied from the battery 71 to the replaced electric actuator (for example, the pump motor). With such a configuration, similar to the above-described embodiment, the battery 71 can be charged with electric power supplied from an external device (for example, the power supply lane 502 or the other asphalt finisher 100). Therefore, the same effects as those of the above-described embodiment can be achieved.

Although the asphalt finishers according to the embodiment and the modifications have been described, the present invention is not limited to the above-described embodiment and the modifications. Various changes, modifications, substitutions, additions, deletions, and combinations are possible within the scope of the claims. Such modifications are also included in the technical scope of the present invention.

What is claimed is:

1. An asphalt finisher comprising:
a tractor;
a hopper provided on a front side of the tractor;
a conveyer configured to convey a pavement material in the hopper to a rear side of the tractor;
a screw configured to lay and spread, in a vehicle width direction, the pavement material conveyed by the conveyer and placed on a road surface;
a screed device configured to lay and level the pavement material laid and spread by the screw behind the screw;
an actuator configured to use electric power to supply power to at least one of the tractor, the conveyer, the screw, or the screed device;
a power storage configured to supply the electric power to the actuator; and
a connection part connectable to an external device and configured to receive supply of electric power from the external device or deliver electric power to the external device,
wherein the connection part is configured to supply the electric power from the external device to the power storage.

2. The asphalt finisher according to claim 1, wherein the connection part is configured to at least deliver the electric power to the external device.

3. The asphalt finisher according to claim 2, wherein the connection part includes
a first connection part connectable to a first external device and configured to receive supply of electric power from the first external device, and
a second connection part connectable to a second external device and configured to deliver the electric power from the first connection part to the second external device.

4. The asphalt finisher according to claim 1, wherein the connection part is connectable to a connection part of another asphalt finisher or to a power supply member provided along a route to be traveled by a vehicle.

5. The asphalt finisher according to claim 3, wherein
in a case where a second connection part of another asphalt finisher is connected to the first connection part of the asphalt finisher, the first connection part of the asphalt finisher is configured to receive supply of electric power from said another asphalt finisher, and
in a case where a first connection part of said another asphalt finisher is connected to the second connection part of the asphalt finisher, the second connection part of the asphalt finisher is configured to deliver electric power to said asphalt finisher.

6. The asphalt finisher according to claim 3, wherein, in a case where a power supply member provided along a route to be traveled by a vehicle is connected to the first connection part, the first connection part is configured to receive supply of electric power from the power supply member.

7. The asphalt finisher according to claim 4, wherein, in a case where the connection part is connected to said another asphalt finisher via a cable, the asphalt finisher performs speed control in accordance with a speed of said another asphalt finisher so as to maintain the connection via the cable.

8. The asphalt finisher according to claim 4, wherein, in a case where the connection part is connected to said another asphalt finisher via a cable, the asphalt finisher performs steering angle control in accordance with a steering angle of said another asphalt finisher so as to maintain the connection via the cable.

9. A power supply system for an asphalt finisher, the power supply system comprising:
an external device; and
the asphalt finisher including
a tractor,
a hopper provided on a front side of the tractor,
a conveyer configured to convey a pavement material in the hopper to a rear side of the tractor,
a screw configured to lay and spread, in a vehicle width direction, the pavement material conveyed by the conveyer and placed on a road surface,
a screed device configured to lay and level the pavement material laid and spread by the screw behind the screw,
an actuator configured to use electric power to supply power to at least one of the tractor, the conveyer, the screw, or the screed device,
a power storage configured to supply the electric power to the actuator, and
a connection part connectable to the external device and configured to receive supply of electric power from the external device or deliver electric power to the external device,
wherein the connection part is configured to supply the electric power from the external device to the power storage.

10. The power supply system for the asphalt finisher according to claim 9, wherein
the external device is a power supply member provided along a route to be traveled by a vehicle, and
the connection part is configured to receive supply of electric power from the power supply member.

11. The power supply system for the asphalt finisher according to claim 10, further comprising:
a member connectable to the connection part and configured to, when connected to the connection part, extend from a side surface of the asphalt finisher in a width direction of the asphalt finisher and supply the electric power from the power supply member, with which one end of the member is in contact, to the connection part.

12. The power supply system for the asphalt finisher according to claim 9, wherein
the external device is another asphalt finisher, and
the connection part is configured to be connectable to a connection part of said another asphalt finisher.
